(19) United States
(12) Patent Application Publication
(10) Pub. No.: US 2002/0175523 A1
(43) Pub. Date: Nov. 28, 2002

(54) Latch device adapted to be mounted on a door of a cabinet to retain the door on the cabinet

(75) Inventor: Francisco Lu, Kaohsiung Hsien (TW)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Interseng Hardware Co., Ltd.

(21) Appl. No.: 09/865,758

(22) Filed: May 25, 2001

(51) Int. Cl. E05C 19/10

(52) U.S. Cl. 292/126

(57) ABSTRACT

A latch device includes a latch body defining a lever-receiving cavity, and is formed with a running passage in spatial communication with the cavity. A shaft is mounted on the latch body and crosses the cavity. A lever is mounted pivotally in the cavity in the latch body, and has a bar engaging section and an operable section. An engagement bar is mounted pivotally on a bottom side of the latch body, and has a cabinet engaging end that extends laterally relative to the bottom side of the latch body, and a lever-activated member that projects in a transverse direction relative to the shaft through the running passage and into the cavity. A tension spring interconnects the latch body and the engagement bar under tension, and retains the cabinet engaging end at a position, where the cabinet engaging end is adapted to engage a cabinet.

### BACKGROUND OF THE INVENTION

1. Field of the Invention

The invention relates to a latch device, more particularly to a latch device that is adapted to be mounted on a door of a cabinet to retain the door on the cabinet.

2. Description of the Related Art

Referring to FIGS. 1 and 2, a conventional latch device 1 is shown to include a latch body 12, a shaft 131, a lever 13, an engagement bar 14, and a torsional spring unit consisting of springs 18,18′.

As illustrated, the latch body 12, which is adapted to be fixed on a door (not shown) of a cabinet, defines a lever-receiving cavity 11, and is formed with a running passage 15 therein which is in spatial communication with the cavity 21. The shaft 131 is mounted on the latch body 12 and crosses the cavity 11. The lever 13 is mounted pivotally in the cavity 11, and is turnable about the shaft 131. The lever 13 has a bar engaging section 133 at one side of the shaft 131, and an operable section 134 at the other side of the shaft 131. The engagement bar 14 is mounted pivotally on a bottom side of the latch body 12 by a pivot that extends transverse to the shaft 131. The engagement bar 14 has a cabinet engaging end 141 that extends laterally relative to the bottom side of the latch body 12 and that is adapted to engage the cabinet (not shown), and a lever-activated member 17 that projects in a transverse direction relative to the shaft 131 through the running passage 15 and into the cavity 11. The cabinet engaging end 141 of the engagement bar 14 is retained at a first position by virtue of biasing action of the springs 18, 18′, where the cabinet engaging end 141 is adapted to engage the cabinet so as to retain the door on the cabinet.

It is noted that the use of two torsional springs 18,18′ in the aforesaid conventional latch device results in higher production costs. In addition, the need to form a spring retention slot 16 in the bottom side of the latch body 12 for retaining the spring 18′ weakens the structural strength of the latch body 12 and involves additional processing expense.

### SUMMARY OF THE INVENTION

Therefore, the object of this invention is to provide a latch device which is adapted to be mounted on a door of a cabinet and which is capable of overcoming the above-stated drawbacks.

Accordingly, a latch device of the present invention is adapted to be mounted on a door of a cabinet to retain the door on the latch relative to the cabinet. The latch device includes a latch body, a shaft, a lever, an engagement bar, and a tension spring. The latch body is adapted to be fixed on the door. The latch body defines a lever-receiving cavity, and is formed with a running passage therein which is in spatial communication with the cavity. The shaft is mounted on the latch body and crosses the cavity. The lever is mounted pivotally in the cavity of the latch body, and is turnable about the shaft. The lever has a bar engaging section at one side of the shaft, and an operable section at the other side of the shaft. The engagement bar is mounted pivotally on a bottom side of the latch body, and has a cabinet engaging end that extends laterally relative to the bottom side of the latch body and that is adapted to engage the cabinet, and a lever-activated member that projects in a transverse direction relative to the shaft through the running passage and into the cavity. The tension spring interconnects the latch body and the engagement bar under tension so as to retain the cabinet engaging end of the engagement bar at a first position, where the cabinet engaging end is adapted to engage the cabinet so as to retain the door on the cabinet.

Rotation of the lever about the shaft by manipulating the operable section of the lever against tension force of the tension spring results in rotation of the engagement bar relative to the latch body via engagement between the bar engaging section of the lever and the lever-activated member of the engagement bar, thereby disposing the cabinet engaging end of the bar at a second position offset from the first position.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is an exploded perspective view of a conventional latch device which is adapted to be mounted on a door of a cabinet;

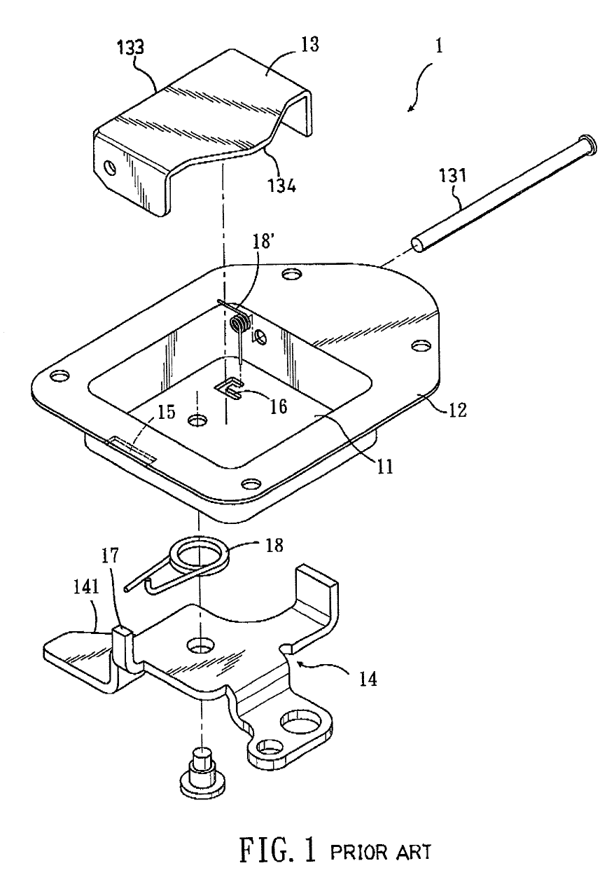

FIG. 2 is a schematic top view of the conventional latch device;

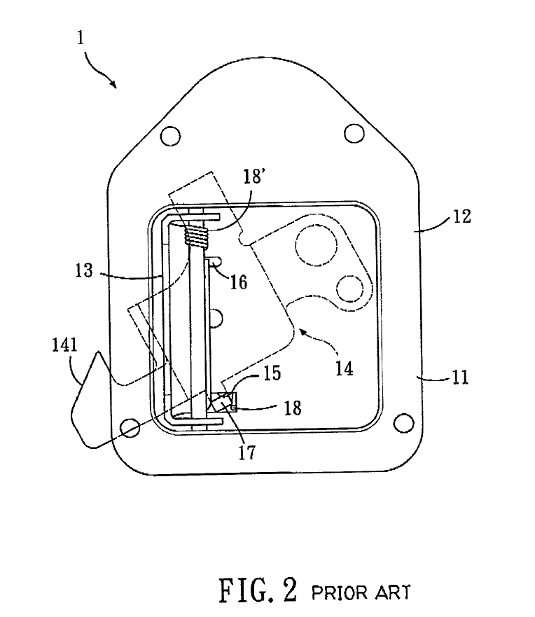

FIG. 3 is an exploded perspective view of a preferred embodiment of a latch device according to the present invention, which is adapted to be mounted on a door of a cabinet;

FIG. 4 is a schematic bottom view of the preferred embodiment, illustrating how an engagement bar is adapted to engage the cabinet so as to retain the door relative to the cabinet; and

FIG. 5 is a schematic top view of the preferred embodiment, illustrating how the engagement bar is adapted to disengage the cabinet by application of an external force against tension of a tension spring.

### DETAILED DESCRIPTION OF THE PREFERRED EMBODIMENT

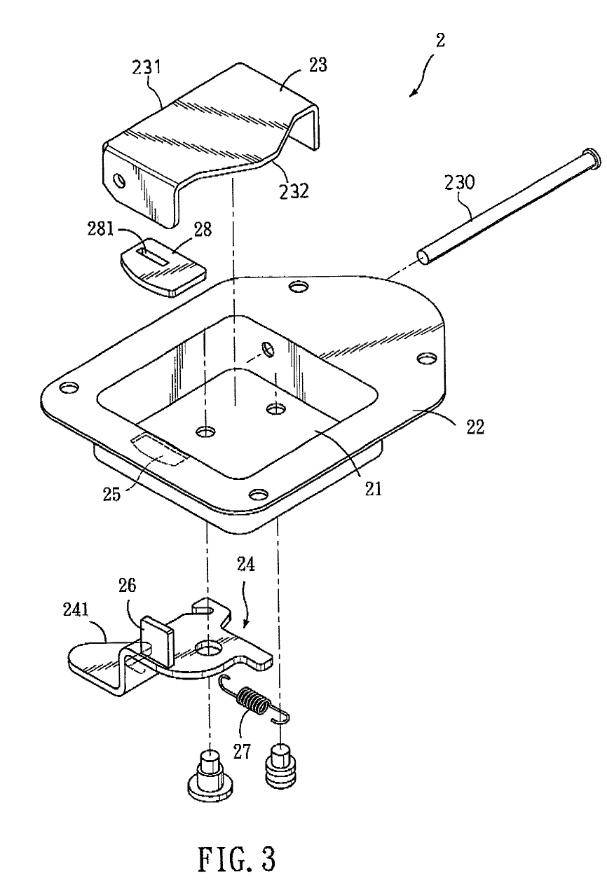

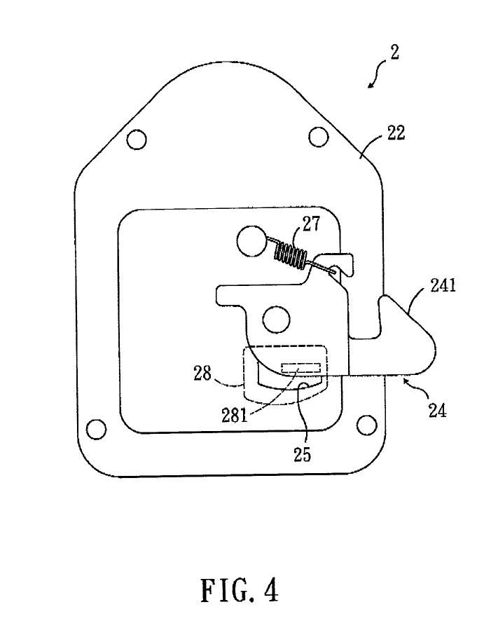

Referring to FIGS. 3 and 4, the preferred embodiment of a latch device 2 according to the present invention is adapted to be mounted on a door (not shown) of a cabinet to retain the door on the cabinet. The latch device 2 includes a latch body 22, a shaft 230, a lever 23, an engagement bar 24, and a tension spring 27.

As illustrated, the latch body 22 is adapted to be fixed on the door (not shown). The latch body 22 defines a lever-receiving cavity 21, and is formed with a running passage 25 therein which is in spatial communication with the cavity 21.

The shaft 230 is mounted on the latch body 22, and crosses the cavity 21.

The lever 23 is mounted pivotally in the cavity 21 of the latch body 22, and is turnable about the shaft 230. The lever 23 has a bar engaging section 231 at one side of the shaft 230, and an operable section 232 at the other side of the shaft 230.

The engagement bar 24 is mounted pivotally on a bottom side of the latch body 22, and has a cabinet engaging end 241 that extends laterally relative to the bottom side of the latch body 22 and that is adapted to engage the cabinet (not shown), and a lever-activated member 26 that projects in a transverse direction relative to the shaft 230 through the running passage 25 and into the cavity 21.

The tension spring 27 interconnects the latch body 22 and the engagement bar 24 under tension, and retains the cabinet engaging end 241 at a first position, as best shown in FIG. 4, where the cabinet engaging end 241 is adapted to engage the cabinet (not shown) so as to retain the door on the cabinet.

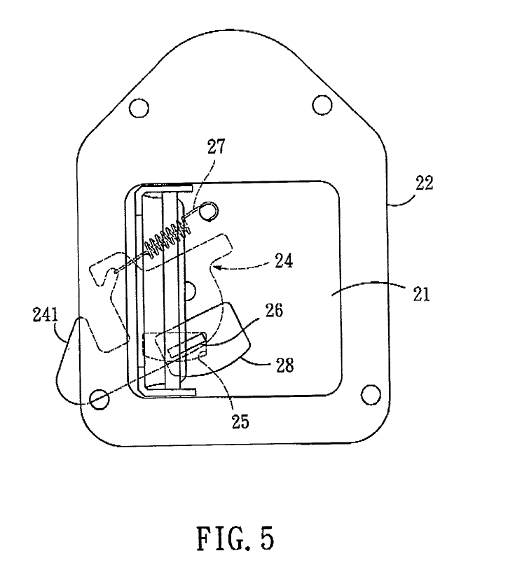

As shown in FIG. 5, when it is desired to open the door (not shown), rotation of the lever 23 about the shaft 230 by manipulation of the operable section 232 of the lever 23 against tension force of the tension spring 27 results in rotation of the engagement bar 24 relative to the latch body 22 via engagement between the bar engaging section 231 of the lever 23 and the lever-activated member 26 of the engagement bar 24, thereby disposing the cabinet engaging end 241 at a second position which is offset from the first position of FIG. 4.

Preferably, an elastic pad 28 is disposed in the cavity 21 in order to cover the running passage 25 of the latch body 22. The elastic pad 28 is formed with an elongated slot 281 through which the lever-activated member 26 extends such that movement of the member 26 in the running passage 25 is not impeded by the elastic pad 28.

The production cost of the preferred embodiment is relatively low, since only a single tension spring 27 is employed and since there is no need to form a slot for retention of the spring 27. Thus, the aforesaid drawbacks encountered in the prior art can be eliminated in the latch device of this invention.

With this invention thus explained, it is apparent that numerous modifications and variations can be made without departing from the scope and spirit of this invention. It is therefore intended that this invention be limited only as indicated in the appended claims.

I claim:

1. A latch device adapted to be mounted on a door of a cabinet to retain the door on the cabinet, comprising:
a latch body adapted to be fixed on the door, said latch body defining a lever-receiving cavity, and being formed with a running passage therein which is in spatial communication with said cavity;
a shaft mounted on said latch body and crossing said cavity;
a lever mounted pivotally in said cavity and turnable about said shaft, said lever having a bar engaging section at one side of said shaft, and an operable section at the other side of said shaft;
an engagement bar mounted pivotally on a bottom side of said latch body, and having a cabinet engaging end that extends laterally relative to said bottom side of said latch body and that is adapted to engage the cabinet, and a lever-activated member that projects in a transverse direction relative to said shaft through said running passage and into said cavity; and
a tension spring interconnecting said latch body and said engagement bar under tension and retaining said cabinet engaging end at a first position, where said cabinet engaging end is adapted to engage the cabinet so as to retain the door on the cabinet;
whereby, rotation of said lever about said shaft by manipulating said operable section of said lever against tension force of said tension spring results in rotation of said engagement bar relative to said latch body via engagement between said bar engaging section of said lever and said lever-activated member of said engagement bar, thereby disposing said cabinet engaging end at a second position offset from said first position.
